(19) United States
(12) Patent Application Publication
(10) Pub. No.: US 2013/0264776 A1
(43) Pub. Date: Oct. 10, 2013

(54) RADIAL SHAFT SEAL RING

(71) Applicant: Juergen Kurth, Odenthal (DE)

(72) Inventor: Juergen Kurth, Odenthal (DE)

(21) Appl. No.: 13/879,860

(22) PCT Filed: Oct. 17, 2011
(86) PCT No.: PCT/EP11/68056

§ 371 Date: Jun. 20, 2013

(30) Foreign Application Priority Data
Oct. 18, 2010 (DE) 102010042555.,9

(51) Int. Cl. F16J 15/32

(52) U.S. Cl. CPC F16J 15/32
USPC 277/549

(57) ABSTRACT

The invention relates to a radial shaft seal ring (1), including a reinforcement ring (3) and an elastomeric part (5) connected to the reinforcement ring (3), which elastomeric part (5) has a sealing lip (9) having a first sealing section (11), which is provided with a thread-like return structure (13) for returning a leaked fluid when a shaft is rotating, and having a second sealing section (15), which has a circular-cylindrical outer surface-shaped sealing surface (19) for gas-tight abutment on a stationary shaft, which circular-cylindrical outer surface-shaped sealing surface (19) has a microstructure (17).

The invention relates to a radial shaft seal ring, including a reinforcement ring and an elastomeric part connected to the reinforcement ring, which elastomeric part has a sealing lip having a first sealing section, which is provided with a thread-like return structure for returning a leaked fluid when a shaft is rotating, and having a second sealing section, which has a circular-cylindrical outer surface-shaped sealing surface for gas-tight abutment on a stationary shaft.

DE 10 2007 036 625 A1 describes a sealing element for sealing a shaft, provided for rotating in accordance with its design, at a through-opening of a housing part for the shaft, which sealing element has a reinforcement part and an elastomeric part connected to the reinforcement part, which elastomeric part comprises a first sealing section for a static sealing abutment on the housing part, and which comprises a second sealing section having a sealing segment formed and provided for sealing abutment on the shaft, which sealing segment comprises a thread-like return structure for a return of a leaked fluid into a to-be-sealed chamber, and a free axial end of the sealing segment abutting on the shaft in accordance with its design is formed with a closed line in the circumferential direction and extending on a circular-cylinder outer surface, which line is provided for sealing abutment on the shaft at least when the shaft is not rotating.

It is an object of the invention to provide a radial shaft seal ring, wherein the return properties during operation of the radial shaft seal ring are improved notwithstanding good sealing properties for testing and verification purposes.

The object of the invention is achieved by a radial shaft seal ring, including a reinforcement ring and an elastomeric part connected to the reinforcement ring, which elastomeric part has a sealing lip having a first sealing section, which is provided with a thread-like return structure for returning a leaked fluid when a shaft is rotating, and having a second sealing section, which has a circular-cylindrical outer surface-shaped sealing surface for gas-tight abutment on a stationary shaft, wherein the circular-cylindrical outer surface-shaped sealing surface has a microstructure.

“Microstructure” is understood to mean elevations and/or recesses in the smooth, i.e. flat, circular-cylindrical outer surface-shaped sealing surface of the second sealing section, wherein the elevations have a height and/or the recesses have a depth which is clearly smaller than the height and/or depth of the thread-like return structure provided for returning a leaked fluid.

In particular, “microstructure” is understood to mean elevations and/or recesses in the smooth, i.e. flat, circular-cylindrical outer surface-shaped sealing surface of the second sealing section, which have a height or depth which is smaller than 0.1 millimeter, in particular smaller than 0.08 millimeter, i.e. smaller than 80 microns.

The microstructures can have a different shape, i.e. pattern. However, the microstructures are formed such that connecting channels are provided between the to-be-sealed fluid chamber, in particular an oil chamber, and the environment sealed therefrom, or the first sealing section which is provided with a thread-like return structure for returning the leaked fluid, in particular oil, when a shaft is rotating.

Conventionally, radial shaft seal rings are formed with a sealing section, which is provided with a thread-like return structure for returning a leaked fluid when a shaft is rotating so that, when a shaft is rotating, the leaked fluid, in particular leaked oil, can be transported back again into the oil chamber. In this design, the return structures draw through the entire abutment width of the sealing lip on the shaft, so that gas can flow through between the sealing lip and the shaft. With a stationary shaft, such a radial shaft seal ring consequently does not seal in a gas-tight manner. In another conventional design, a second sealing section having a circular-cylindrical outer surface-shaped sealing surface for gas-tight abutment on a stationary shaft is therefore provided between the fluid chamber or oil chamber and the sealing section, which sealing section is provided with a thread-like return structure for returning the leaked fluid. To a achieve gas-tightness, this second sealing section is generally always flat, i.e. evenly formed.

Thus the elastomeric part can comprise a second sealing region having a sealing section formed and provided for sealing abutment on the shaft, which sealing section comprises a thread-like return structure for a return of a leaked fluid into a to-be-sealed chamber, and a free axial end of the sealing section abutting on the shaft in accordance with its design is formed with a closed line in the circumferential direction and extending on a circular-cylinder outer surface, which line is provided for sealing abutment on the shaft at least when the shaft is not rotating. Taking into account the application-specific requirements for sealing, durability, friction and power loss, such a sealing element thus offers the advantage of automated installation and inspection by a subsequently-following gas-leakage test. Because the dynamic sealing region is manufactured from an elastomer material, the sealing section has a high elasticity, in particular with respect to a comparable embodiment made from PTFE, whereby a defined static gas-tight contact is possible due to the abutment capability of the sealing section, in particular of the closed line on a counterface of the shaft, which line extends radially on the circular-cylindrical outer surface, whereby in turn said pressure and/or vacuum testing is possible in an advantageous manner.

By providing a second sealing section in an inventive manner, which second sealing section has a circular-cylindrical outer surface-shaped sealing surface for gas-tight abutment on a stationary shaft, which sealing surface has a microstructure, gas tightness is maintained when the shaft is stationary and, when the shaft is rotating, the return-flow capability of the first sealing section, which has the thread-like return structures for the leaked fluid, is improved. When the shaft is stationary, leaked fluid or leakage oil rests in the microstructures, so that gas tightness is maintained at rest. On the other hand, when the shaft is rotating the microstructures ensure passages for the leaked fluid or leaked oil, so that the leaked fluid or leaked oil returned from the thread-like return structures of the first sealing section can overcome or pass the second sealing section, whereby the return-flow capability of the radial shaft end ring is improved overall.

With an inventive microstructure it can be unnecessary that the second sealing section must be formed such that the second sealing section floats when a shaft is rotating, in order to generally make possible a return of the leaked fluid or leaked oil. With an inventive microstructure, the second sealing section can be formed such that when the shaft is rotating it does not float, or at least it floats less than this would be necessary with a smooth circular-cylindrical outer surface-shaped sealing surface. The sealing effect can thereby also be improved overall.

In all inventive embodiments, oil can for example be understood as the leaked fluid.

The microstructure can be embodied to form channels which, when the shaft is stationary, are gas-tight due to a wetting by the leaked fluid and, when the shaft is rotating in accordance with its design, permit a return of the leaked fluid across the circular-cylindrical outer surface-shaped sealing surface abutting on the shaft outwardly through the channels. The channels can be designed as straight, curved, or bent. Channels with different paths can be combined with one another. In particular, identical channels, in particular straight-extending channels, can be formed disposed in a plurality at a uniform spacing from one another on the circular-cylindrical outer surface-shaped sealing surface.

In all embodiments of the invention, the microstructure can be embodied to form channels which extend across the entire axial width of the circular-cylindrical outer surface-shaped sealing surface. In other words, the channels connect an oil chamber with the annular gap which is formed by the shaft and the first sealing section, which is provided with the thread-like return structure for returning the leaked fluid when a shaft is rotating. The second sealing section or the circular-cylindrical outer surface-shaped sealing surface thus lies between the first sealing section and the oil chamber.

The microstructure can be embodied to form straight channels, in particular to form straight channels which are oriented at an acute angle of incidence, in particular at an acute angle of incidence of 15 degrees to 25 degrees, to a sealing edge end of the circular-cylindrical outer surface-shaped sealing surface. Due to the formation of the channels with an acute angle of incidence, in particular with an acute angle of incidence of 15 degrees to 25 degrees, the microstructure also has a pumping effect. The pumping direction of the microstructures corresponds to the pumping direction of the first sealing section.

In all embodiments of the invention, the microstructure can have ridges or grooves, which have a structural depth of 1 to 80 microns, in particular of 5 to 50 microns. Ridges and grooves can alternate. Grooves can be formed such that flat sections of the circular-cylindrical outer surface-shaped sealing surface are delimited by two ridges. Ridges can be formed such that flat sections of the circular-cylindrical outer surface-shaped sealing surface are delimited by two grooves.

In all embodiments of the invention, the microstructure, in particular the channels, the ridges, and/or the grooves, can connect directly to the first sealing section.

In all embodiments of the invention, the microstructure, in particular the channels, the ridges, and/or the grooves, can continue or extend into the thread-like return structure of the first sealing section.

According to an embodiment of the invention, two or more channels, ridges, and/or grooves of the microstructure can each be associated with an end of the thread-like return structure and/or can continue or extend onto a ridge or into a groove of the thread-like return structure of the first sealing section.

In all exemplary embodiments of the invention, the microstructures, in particular the channels, the ridges, and/or the grooves, can be microstructures, channels, ridges, and/or grooves that are applied or introduced using known laser-processing methods onto the circular-cylindrical outer surface-shaped sealing surface.

In all exemplary embodiments of the invention, the microstructures, in particular the channels, the ridges, and/or the grooves can be microstructures, channels, ridges, and/or grooves produced during the manufacture of the radial shaft seal ring, in that corresponding negative structures are applied or introduced using known laser-processing methods onto a surface of a mold for manufacturing the radial shaft seal ring.

In summary, the invention can thus provide a solution in particular for reduced-friction radial shaft seal rings made from elastomer materials.

Reduced-friction radial shaft seal rings made from elastomer materials are embodied, among other things, with a spiral-shaped oil return apparatus and a static dam for gas tightness at rest. This dam, which forms the inventive second sealing section, which has a circular-cylindrical outer surface-shaped sealing surface for gas-tight abutment on a stationary shaft, can ensure a control of a functionally correct installation of a sealing lip or a radial shaft seal ring, such that during a gas-tightness testing of a machine, such as for example a motor which includes a shaft and an inventive radial shaft seal ring, the dam or the second sealing section having a circular-cylindrical outer surface-shaped sealing surface abuts gas-tight on the shaft when the shaft is stationary.

The dam or the second sealing section having a smooth circular-cylindrical outer surface-shaped sealing surface locally seals the oil return apparatus (thread-like return structure) and reduces or even inhibits the return capability of the sealing lip.

The invention aims to produce, for example, channels and/or ridges on the contact strip of the static dam or of the second sealing section using oriented microstructures, which channels and/or bridges are sufficiently gas-pressure-tight, at least with a fluid wetting, for example with an oil, in order to suffice for any required mounting final inspection, when the shaft is stationary, and to promote a return transport of the leaked fluid, in particular of the oil between shaft surface and dam, during operation of the seal, i.e. when the shaft is rotating.

A feature of reduced-friction radial shaft seals having elastomer surface supports and return spirals is the very low abrasion and thus the low wear of the elastomer sealing lip contact regions. The pumping mechanisms can thereby be maintained in the micrometer range even over the service life of the seal.

Manufacturing methods for producing ridges or grooves to sufficient precision are available with the known laser-processing technologies. These pumping structures, i.e. microstructures, can be introduced directly into the sealing lip of the shaft seal ring or introduced in the seal-lip-forming mold part of the vulcanizing tool. The structural depth can be designed in the range from 1 μm to 80 μm, preferably in the range from 5 μm to 50 μm.

An angle of incidence of the pumping structures, i.e. of the microstructures, can be in the range from 15 degrees to 25 degrees to the sealing edge end.

At least one pumping element, up to a multiplicity of partially-radially-overlapping elements, can be designed.

Such capillary microstructures on the sealing lip of the shaft seal ring or on the second sealing section facilitate the oil return underneath the static dam, but also simultaneously form lubricant reservoirs in the contact zone which positively influence the friction and temperature at critical operating points.

Under static conditions, a small open cross-section of the pumping elements forms a sufficiently large pressure drop over its length, so that pressure tests, for example of an internal combustion engine, are withstood, without leakages resulting during the pressure test.

Exemplary embodiments of the invention are illustrated in the appended schematic drawings in an exemplary manner.

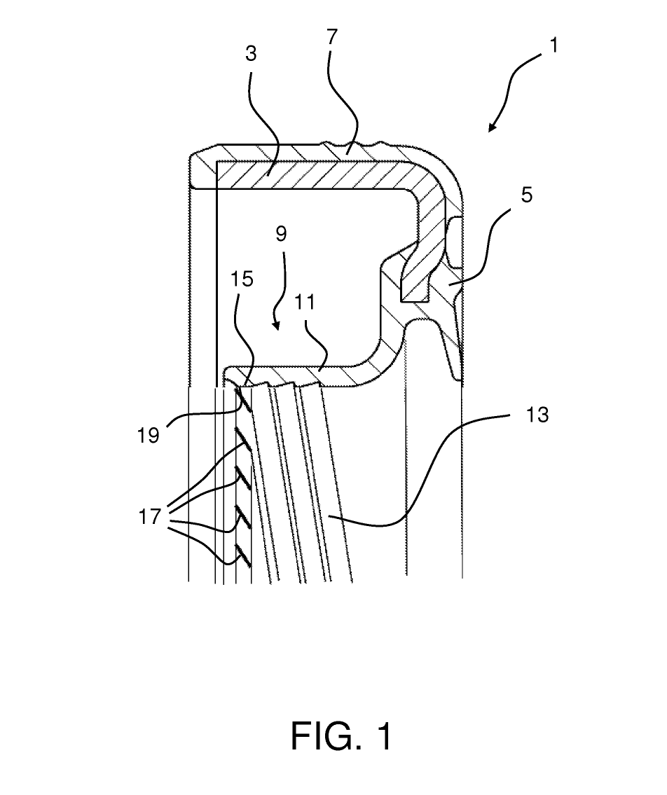

FIG. 1 shows a longitudinal section through an upper half of a radial shaft seal ring having an inventive second sealing section, whose circular-cylindrical outer surface-shaped sealing surface has a microstructure;

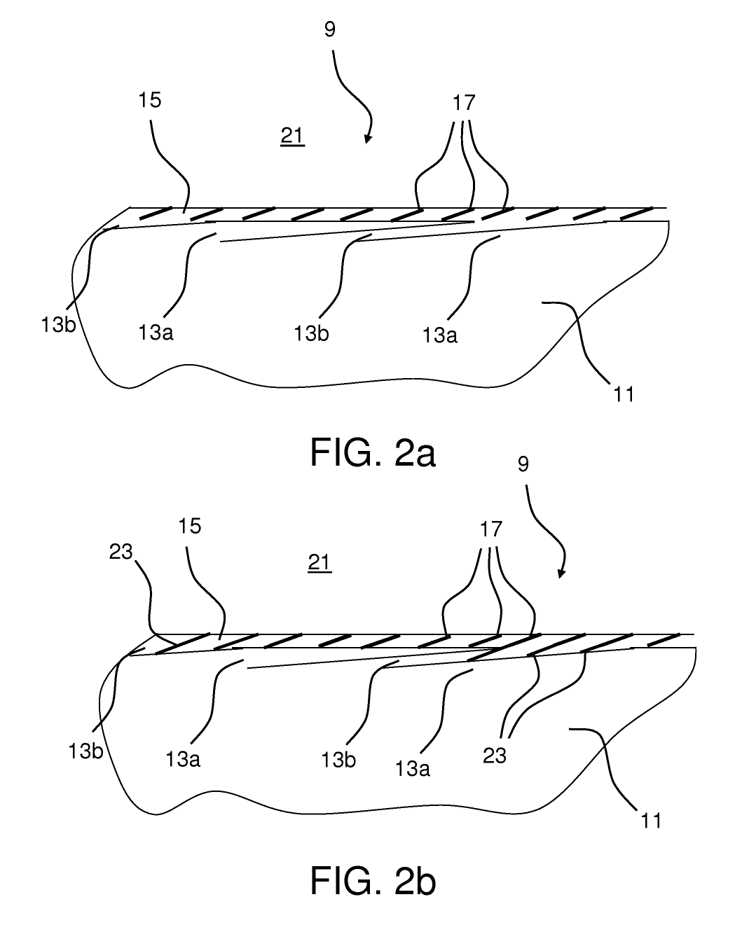

FIG. 2a shows a schematic illustration of a developed view of a cut-out from the first and second sealing section in a plan view in a first embodiment;

FIG. 2b shows a schematic illustration of a developed view of a cut-out from the first and second sealing section in a plan view in a second embodiment;

FIG. 1 shows, as an exemplary embodiment of the invention, a longitudinal section through an upper half of a radial shaft seal ring 1. Here the radial shaft seal ring 1 includes a reinforcement ring 3 as well as a one-piece-formed elastomeric part 5 connected to the reinforcement ring 3. The reinforcement ring 3 here is manufactured for example from a metal plate. The elastomeric part 5 is formed from an elastomer material, in particular a fluoroelastomer, which can contain PTFE nanoparticles, and, is connected to the reinforcement ring 3, by a vulcanization with it.

The elastomeric part 5 has a static sealing region 7, whose outer surface is formed for static sealing abutment on a not-shown housing part in the region of a through-opening for a to-be-sealed, also not-shown, shaft. Here this can be for example an internal combustion engine, wherein an oil chamber of the engine is disposed on the left side of FIG. 1 and, for example, one of the air sides associated with the surrounding atmosphere is located on the right side of FIG. 1.

The elastomeric part 5 has a sealing lip 9, which abuts on the not-shown shaft when the radial shaft seal ring 1 is installed in accordance with its design. The sealing lip 9 has a first sealing section 11. This first sealing section 11 is provided with a thread-like return structure 13. The thread-like return structure 13 is illustrated greatly exaggerated in FIG. 1, in order to make more clearly visible the thread-like passages of the return structure 13 and their transition and/or discontinuing into a second sealing section 15. Instead of the three revolutions of passages shown, the return structure 13 can also have less than three passages, down to one passage. The pitch of the passages is actually much smaller than illustrated. The pitch of the passages can for example be 0.7 or 0.75 mm.

The sealing lip 9 carries the second sealing section 15 on a free end facing towards the oil chamber. The second sealing section 15 has an inventive microstructure 17. The microstructure 17 is applied or introduced on a circular-cylinder outer surface-shaped sealing surface 19 of the second sealing section 15.

As illustrated in the exemplary embodiment of FIG. 1, the microstructures 17 can be embodied to form channels that, when the shaft is stationary (not shown), are gas-tight due to a wetting by the leaked fluid and, when the shaft is rotating in accordance with its design, permit a return of the leaked fluid across the circular-cylindrical outer surface-shaped sealing surface 19 abutting on the shaft outwardly through the channels.

The channels of the microstructures 17 extend across the entire axial width of the circular-cylindrical outer surface-shaped sealing surface 19. The microstructures 17 connect directly to the first sealing section 11.

In each of FIGS. 2a and 2b, a developed view of a cut-out from the first sealing section 11 and the second sealing section 15, i.e. a segment of the radial shaft seal ring 1, is illustrated in plan view as observed from the inside.

In this respect, FIGS. 2a and 2b show an arc section of the sealing lip 9. The first sealing section 11 carries the thread-like return structure 13, which is provided for returning a leaked fluid when a shaft is rotating. The second sealing section 15, which has the circular-cylindrical outer surface-shaped sealing surface 19 for gas-tight abutment on a stationary shaft, adjoins a side of the sealing lip 9 facing towards an oil chamber 21.

The second sealing surface 15 or the circular-cylindrical outer surface-shaped sealing surface 19 has the microstructure 17. The thread-like return structure 13 consists of an alternating arrangement of pumping grooves 13a and pumping ridges 13b. The thread-like return structure 13 or the alternating arrangement of pumping grooves 13a and pumping ridges 13b is illustrated greatly exaggerated in FIGS. 2a and 2b, i.e. with a clearly larger pitch and with clearly larger widths of the pumping grooves 13a and pumping ridges 13b, in order to better be able to visualize the transition from the first sealing section 11 to the second sealing section 15. In the illustrated exemplary embodiment of FIG. 2a, the microstructure 17 is formed by straight channels, which are oriented in an acute angle of incidence to a sealing edge end of the circular-cylindrical outer surface-shaped sealing surface 19.

In an alternate embodiment according to FIG. 2b, the channels continue in the form of extensions 23 into the thread-like return structure of the first sealing section or the extensions 23 of the channels reach into the thread-like return structure. This is shown in FIG. 2b by the extensions 23 of the microstructure 17 as compared with the embodiment according to FIG. 2a.

### REFERENCE NUMBER LIST

1 Radial shaft seal ring
3 Reinforcement ring
5 Elastomeric part
7 Static sealing area
9 Sealing lip
11 First sealing section
13 Return structure
15 Second sealing section
17 Microstructure
19 Sealing surface
21 Oil chamber
23 Extensions

1. Radial shaft seal ring, including a reinforcement ring (3) and an elastomeric part (5) connected to the reinforcement ring (3), which elastomeric part (5) has a sealing lip (9) having a first sealing section (11), which is provided with a thread-like return structure (13) for returning a leaked fluid when a shaft is rotating, and having a second sealing section (15), which has a circular-cylindrical outer surface-shaped sealing surface (19) for gas-tight abutment on a stationary shaft, characterized in that the circular-cylindrical outer surface-shaped sealing surface (19) has a microstructure (17).

2. Radial shaft seal ring according to claim 1, characterized in that the microstructure (17) is embodied to form channels, which when the shaft is stationary are gas-tight due to a wetting by the leaked fluid, and when the shaft is rotating in accordance with its design permits a return flow of the leaked fluid across the circular-cylindrical outer surface-shaped sealing surface (19) abutting on the shaft outwardly through the channels.

3. Radial shaft seal ring according to claim 1 or 2, characterized in that the microstructure (17) is embodied to form channels which extend across the entire axial width of the circular-cylindrical outer surface-shaped sealing surface (19).

4. Radial shaft seal ring according to claim 3, characterized in that the microstructure (17) is embodied to form straight channels, in particular to form straight channels which are oriented at an acute angle of incidence, in particular at an angle of incidence of 15 degrees to 25 degrees, to a sealing edge end of the circular-cylindrical outer surface-shaped sealing surface (19).

5. Radial shaft seal ring according to one of claims 1 to 4, wherein the microstructure (17) forms ridges and/or grooves, which have a structural depth of 1 to 80 microns, in particular of 5 to 50 microns.

6. Radial shaft seal ring according to one of claims 1 to 5, characterized in that the microstructure (17), in particular the channels, the ridges, and/or the grooves, directly connects to the first sealing section (11).

7. Radial shaft seal ring according to one of claims 1 to 6, characterized in that the microstructure (17), in particular the channels, the ridges, and/or the grooves, continue or extend into the thread-like return structure (13) of the first sealing section (11).

8. Radial shaft seal ring according to claim 7, wherein two or more channels, ridges, and/or grooves of the microstructure (17) are each associated with an end of the thread-like return structure (13) and/or continue or extend onto a ridge or into a groove of the thread-like return structure (13) of the first sealing section (11).

9. Radial shaft seal ring according to one of claims 1 to 8, characterized in that the microstructures (17), in particular the channels, the ridges, and or the grooves, are microstructures (17), channels, ridges, and/or grooves that are applied or introduced using laser processing onto the circular-cylindrical outer surface-shaped sealing surface (19).

10. Radial shaft seal ring according to one of claims 1 to 9, characterized in that the microstructures (17), in particular the channels, the ridges, and/or the grooves, are microstructures (17), channels, ridges, and/or grooves produced during the manufacture of the radial shaft seal ring (1), in that corresponding negative structures are applied or introduced using laser processing onto a surface of a mold for manufacturing the radial shaft seal ring (1).
